(19) United States
(12) Patent Application Publication
(10) Pub. No.: US 2008/0145082 A1
(43) Pub. Date: Jun. 19, 2008

(54) Development Unit and Image Forming Apparatus

(75) Inventors: Mikio FURUMIZU, Matsumoto-shi (JP); Nobuyuki MIZUSHIMA, Shiojiri-shi (JP); Makoto MATSUSHITA, Sennan-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/949,660

(22) Filed: Dec. 3, 2007

(30) Foreign Application Priority Data
Dec. 11, 2006 (JP) 2006-333144

(51) Int. Cl. G03G 15/16

(52) U.S. Cl. 399/66

(57) ABSTRACT

A development unit includes: an image carrier; a charger that charges the image carrier; an image writing means for forming a latent image on the image carrier; a developer carrier that develops the latent image on the image carrier; and an image write control means for allowing the image writing means to preliminarily expose the image carrier before the position on the image carrier at which an image is to be formed at the time of printing operation is passed through the image writing means.

### CROSS-REFERENCE TO RELATED APPLICATIONS

This application is based upon and claims the benefit of priority from prior Japanese Patent Application No. 2006-333144, filed Dec. 11, 2006, the entire contents of which are incorporated herein by reference.

### BACKGROUND OF THE INVENTION

1. Field of the Invention

The present invention relates to a development unit for developing an image on an image carrier and an image forming apparatus.

2. Description of the Related Art

Generally, a toner image forming means of an electrophotographic type includes a photoconductor serving as an image carrier and having a photosensitive layer on the outer circumferential surface thereof, a charge means for uniformly charging the outer circumferential surface of the photoconductor, an exposure means for selectively exposing the outer circumferential surface uniformly charged by the charge means to form an electrostatic latent image, and a development means for supplying toner which is developer to the electrostatic latent image formed by the exposure means to form a visible image (toner image).

As an image forming apparatus of a rotary type for forming a color image, there is known a transfer belt type color image forming apparatus, in which the toner image forming means as described above is disposed opposite to a primary transfer belt. In this configuration, toner images on the photoconductors formed by the toner image forming means are sequentially transferred onto the primary transfer belt to superimpose toner images of a plurality of colors (e.g., yellow, cyan, magenta, and black) on the primary transfer belt, whereby a color image is obtained on the primary transfer belt.

Among such image forming apparatuses, there is known one having a transfer belt for transferring an image formed on a photoconductor. However, in the image forming apparatus having such a configuration, a positional error occurs between the photoconductor and transfer belt due to accumulation of a slight difference between the peripheral speed of the photoconductor and feeding speed of the transfer belt, electrostatic adsorption between the photoconductor and transfer belt caused by bias application before printing, or reduction in friction occurring when toner is fed in an electrostatically adsorbed state to a transfer position, which may cause registration shift (color shift) as shown in FIG. 6 when toner of a plurality of colors are used to perform transfer processing.

In order to cope with this problem, there has been proposed an image forming apparatus that applies a transfer bias for primary transfer of an toner image from the photoconductor to transfer belt immediately before the leading end of the toner image reaches the transfer position so as to prevent an increase in friction force and occurrence of positional error between the photoconductor and transfer belt (Patent Document 1: JP-A-11-218994).

However, the invention of the Patent Document 1 only considers a bias for primary transfer but does not consider a relationship with other components, resulting in unsatisfactory performance.

### SUMMARY OF THE INVENTION

The present invention has been made in view of the problem inherent in the prior art, and an object thereof is to provide a development unit and image forming apparatus capable of maintaining a high transfer efficiency, as well as obtaining a clear image.

In order to achieve the above object, according to a first aspect of the present invention, there is provided a development unit including: an image carrier; a charger that charges the image carrier; an image writing means for forming a latent image on the image carrier; a developer carrier that develops the latent image on the image carrier; and an image write control means for allowing the image writing means to preliminarily expose the image carrier before the position on the image carrier at which an image is to be formed at the time of printing operation is passed through the image writing means. With the above configuration, it is possible to reduce the potential difference between the image carrier and transfer member, suppress electrostatic adsorption to thereby reduce the registration shift amount, maintain a high transfer efficiency, and obtain a clear image.

The image writing means preliminarily exposes 5% or more of the image forming area on the image carrier. Thus, it is possible to further increase a transfer efficiency and obtain a clear image.

A pattern of the preliminary exposure is a uniform pattern. This suppresses occurrence of positive memory phenomenon on the image carrier.

Further, in order to achieve the above object, according to a second aspect of the present invention, there is provided an image forming apparatus including: an image carrier; a charger that charges the image carrier; an image writing means for forming a latent image on the image carrier; a developer carrier that develops the latent image on the image carrier; a transfer member onto which the developed image is transferred; a secondary transfer portion at which the image on the transfer member is transferred onto a transfer medium; a fixing unit that fixes the image on the transfer medium; an image write control means for allowing the image writing means to preliminarily expose the image carrier before the position on the image carrier at which an image is to be formed at the time of printing operation is passed through the image writing means; and a transfer bias control means for applying a transfer bias before the position on the image carrier at which an image has been formed at the time of printing operation reaches the nip portion between the image carrier and transfer member. With the above configuration, it is possible to suppress electrostatic adsorption to thereby reduce the registration shift amount, maintain a high transfer efficiency, and obtain a clear image.

The transfer bias control means first applies a first transfer bias and, after that, applies a second transfer bias larger than the first transfer bias immediately before the position on the image carrier at which an image has been formed reaches the nip portion between the image carrier and transfer member. This configuration stabilizes a power source, thereby obtaining a clear image.

Further, in order to achieve the above object, according to a third aspect of the present invention, there is provided an image forming apparatus including: an image carrier; a charger that charges the image carrier; an image writing means for forming a latent image on the image carrier; a developer carrier that develops the latent image on the image carrier; a transfer member onto which the developed image is transferred; a secondary transfer portion at which the image on the transfer member is transferred onto a transfer medium; a fixing unit that fixes the image on the transfer medium; an image write control means for allowing the image writing means to preliminarily expose the image carrier before the position on the image carrier at which an image is to be formed at the time of printing operation is passed through the image writing operation; and a charging bias control means for applying a charging bias immediately before the position on the image carrier at which an image is to be formed at the time of printing operation is passed through the charger. With the above configuration, it is possible to maintain a high transfer efficiency, and obtain a clear image.

The charging bias control means first applies a first charging bias and, after that, applies a second charging bias larger than the first charging bias immediately before the position on the image carrier at which an image is to be formed is passed through the charger. Thus, it is possible to previously erase an image remaining on the image carrier before the turn-on of a development bias, thereby obtaining a clear image.

The transfer member is a transfer belt composed of two or more layers. This configuration suppresses a short gap discharge before transfer operation, allowing a sufficient transfer electric field to be applied, which increases a transfer efficiency to thereby obtain a clear image.

The transfer member is composed of a back surface layer positioned on the inner circumferential side, an outermost surface layer positioned on the outer circumferential side, and an intermediate layer sandwiched between the back surface layer and outermost surface layer, and the following condition is satisfied with respect to the resistance values of the three layers: back surface layer resistance value>outermost surface layer resistance value>intermediate layer resistance value. This configuration further increases a transfer efficiency, thereby obtaining a clear image.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

The invention will be described with reference to the accompanying drawings, wherein like numbers reference like elements;

FIG. 1 is a vertical cross-sectional view showing an image forming apparatus according to a first embodiment;

FIG. 2 is a cross-sectional view of a primary transfer belt according to the first embodiment;

FIG. 3 is a view showing a timing chart according to the first embodiment;

FIG. 4 is a view showing the registration shift amount in the first embodiment and comparative examples;

FIG. 5 is a view showing a timing chart according to a second embodiment; and

FIG. 6 is a view showing the registration shift amount in a prior art.

### DETAILED DESCRIPTION OF THE PREFERRED EMBODIMENTS

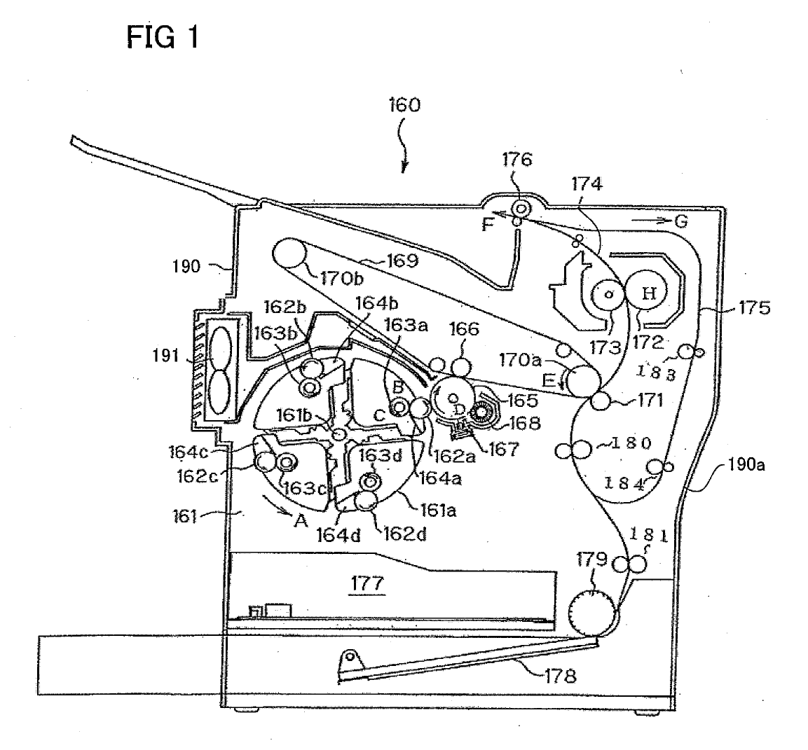

Embodiments of the present invention will be described with reference to the accompanying drawings. FIG. 1 is a vertical cross-sectional view showing an image forming apparatus according to a first embodiment. As shown in FIG. 1, an image forming apparatus 160 includes, as main components, a rotary development unit 161, a photoconductor drum 165 serving as an image carrier, an image writing means (exposure means) 167 having a line head using a light-emitting device such as an organic EL array and a scanning optical system using laser light as a light source, a primary transfer belt 169 as a transfer member, a sheet feeding path 174, a heating roller 172 of a fixing unit, a sheet supply tray 178, and the like.

In the development unit 161, development rotary 161a is rotated in the direction of an arrow A about a rotary shaft 161b. The inside of the development rotary 161a is divided into four parts in which image forming units of four colors (yellow (Y), cyan (C), magenta (M), and black (K)) are respectively provided. Reference numerals 162a to 162d are development rollers which are disposed in the respective image forming units of four colors and each serve as a toner carrier rotated in the direction of an arrow B. Reference numerals 163a to 163d are toner supply rollers rotated in the direction of an arrow C. Reference numerals 164a to 164d are restricting blades for restricting the thickness of toner to a predetermined thickness.

The photoconductor drum 165 is driven to be rotated by a not-shown drive motor such as a step motor in the direction of an arrow D, which is the opposite direction to the rotation direction of the development roller 162a. The primary transfer belt 169 is wound between a driven roller 170b and drive roller 170a. The drive roller 170a is connected to the drive motor of the photoconductor drum 165 and thereby a power is transmitted to the primary transfer belt 169. The drive roller 170a of the primary transfer belt 169 is rotated by the drive of the drive motor in the direction of an arrow E, which is the opposite direction of the rotation direction of the photoconductor drum 165.

Transfer operation from the development unit 161 to the primary transfer belt 169 in the image forming apparatus 160 having the above configuration will be described. First, toner is supplied from the toner supply roller 163 to the development roller 162. At this time, the toner amount is controlled by the restricting blade 164. The development roller 162 is charged by a charger 168 to develop a latent image on the photoconductor drum 165 which has been formed by the line head 167 or the like. An image on the photoconductor drum 165 is then transferred onto the primary transfer belt 169.

A plurality of feeding rollers, sheet discharge roller pair 176, and the like are provided for sheet feeding operation along the sheet feeding path 174. One-side image (toner image) carried by the primary transfer belt 169 is transferred onto one surface of a sheet at the position corresponding to a secondary transfer roller 171. The secondary transfer roller 171 is separated from and brought into contact with the primary transfer belt 169 by a clutch. When the clutch is turned on, the secondary transfer roller 171 is brought into contact with the primary transfer belt 169 and an image is transferred onto a sheet.

The sheet onto which an image has been transferred undergoes fixing processing in the fixing unit having a fixing heater H. The fixing unit includes a heating roller 172 and a reversed crown shaped pressing roller 173. After the fixing process, the sheet is pulled by the sheet discharge roller pair 176 so as to be transferred in the direction of an arrow F. In this state, when the sheet discharge roller pair 176 rotates in the opposite direction to reverse the sheet feeding direction, the sheet passes through a double side printing feeding path (double-side feeding path) 175 in the direction of an arrow G. A reference numeral 183 denotes a pair of first double side rollers, 184 denotes a pair of second double side rollers, 177 denotes an electric component box, 178 denotes a sheet supply tray for storing the sheet, 179 denotes a pick-up roller provided at the outlet of the sheet supply tray 178. An exhaust fan 191 is provided in a housing case 190. An openable cover 190a for pulling out a jammed recording sheet is formed on the sheet feeding path 174 side of the housing case 190.

A pair of feeding rollers 181 are provided along the sheet feeding path 174 for single side printing on the sheet feeding downstream side relative to the pick-up roller 179. Further, a pair of gate rollers 180 are provided on the sheet feeding direction upstream side relative to the secondary transfer roller 171.

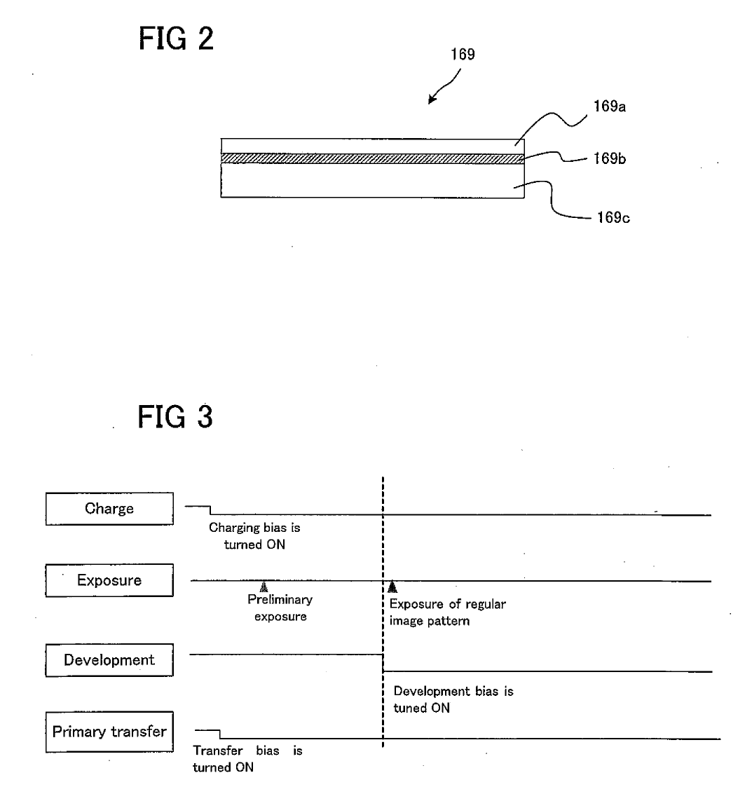

FIG. 2 is a cross-sectional view of the primary transfer belt 169. As shown in FIG. 2, the primary transfer belt 169 is composed of at least three layers of an outermost surface layer 169a positioned on the outer circumferential side, an intermediate layer 169b, and a back surface layer 169c positioned on the inner circumferential side. The outermost surface layer 169a is made of tin, fluorine, and urethane, the intermediate layer 169b is made of tin, and back surface layer 169c is made of PET. The resistivity of the outermost surface layer 169a is set to about 10⁹ Ω·cm, that of the intermediate layer 169b is to about 10⁻² Ω·cm, and that of the back surface layer 169c is to about 10¹⁵ Ω·cm. As described above, it is preferable that a condition: back surface layer resistivity>outermost surface layer resistivity>intermediate layer resistivity be satisfied.

FIG. 3 is a timing chart showing timings of the charge, exposure, development, and primary transfer in the first embodiment. In FIG. 3, a dotted line extending in the up-down direction represents the time point at which a development bias is applied.

In the present embodiment, before a development bias is tuned ON, a charging bias control means applies a bias to the charger 168 to charge the photoconductor drum 165 and a transfer bias control means applies a bias to the primary transfer belt 169. Then, the image writing means 167 preliminarily exposes the photoconductor 165. After that, the development bias is turned on to execute exposure of a regular image pattern.

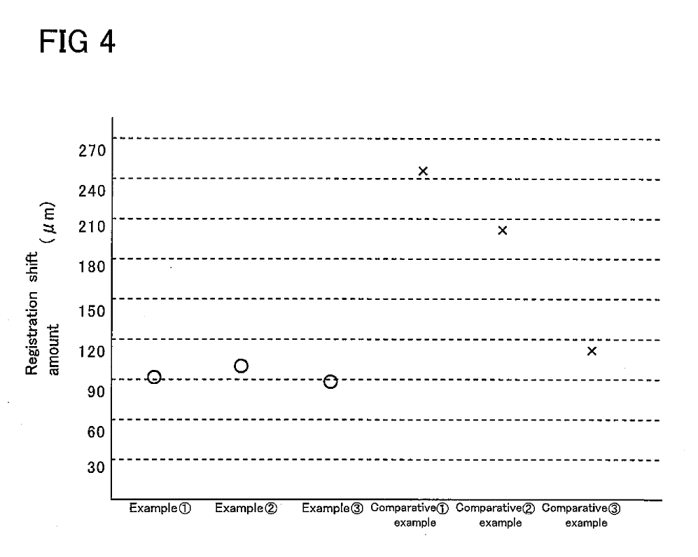

FIG. 4 is a graph comparing the present embodiment with other examples with respect to the registration shift amount. In Example 1, a print test was conducted under a condition that 50% of the photoconductor image area was preliminarily exposed before the turn-on of the development bias. The registration shift amount in Example 1 was about 90 μm.

In Example 2, a print test was conducted under a condition that 5% or more of the photoconductor image area was preliminarily exposed before the turn-on of the development bias. The registration shift amount in Example 2 was about 100 μm.

In Example 3, a print test was conducted under a condition that 50% of the photoconductor image area was preliminarily exposed with a uniform dot pattern before the turn-on of the development bias. The registration shift amount in Example 3 was about 90 μm.

Next, Comparative examples are shown. In Comparative example 1, a print test was performed without execution of the preliminary exposure. The registration shift amount in Comparative example 1 was about 250 μm.

In Comparative example 2, a print test was conducted under a condition that about 1% of the photoconductor image area was preliminarily exposed before the turn-on of the development bias. The registration shift amount in Comparative example 2 was about 200 μm.

In Comparative example 3, a print test was conducted under a condition that 50% of the photoconductor image area was preliminarily exposed with a linear pattern before the turn-on of the development bias. Although the registration shift amount in Comparative example 3 was about 110 μm, “positive memory” phenomenon was recognized on the photoconductor drum 165.

As described above, the image forming apparatus of the present embodiment is capable of reducing the registration shift amount and maintaining a high transfer efficiency, as well as obtaining a clear image.

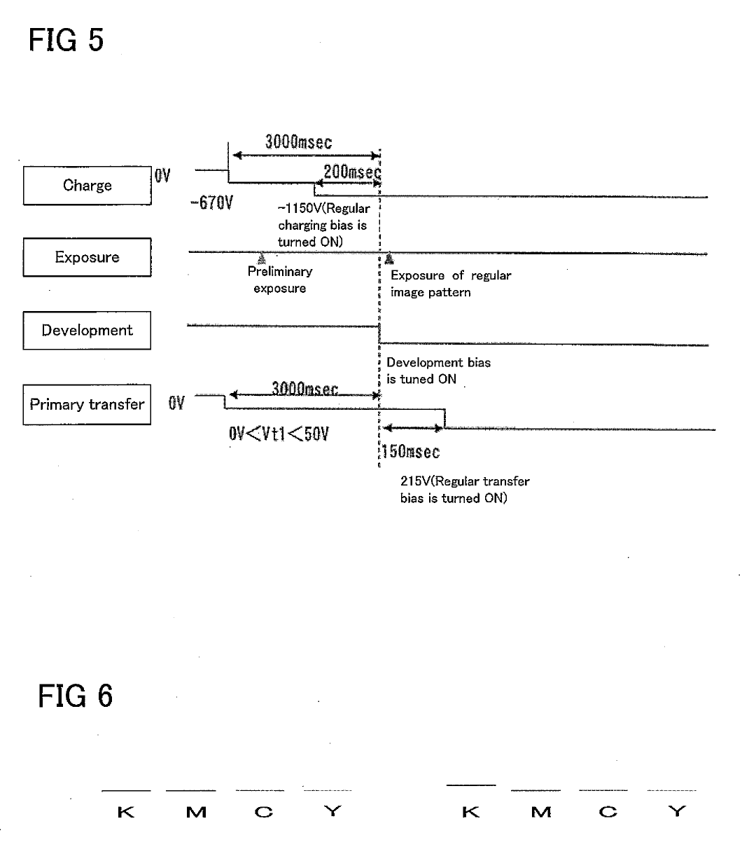

FIG. 5 is a timing chart showing timings of the charge, exposure, development, and primary transfer in a second embodiment. The timings of the charge and primary transfer differ from those of the first embodiment. In FIG. 5, a dotted line extending in the up-down direction represents the time point at which a development bias is applied.

In the present embodiment, about 3000 msec before the turn-on of the development bias, the charging bias control means previously applies, as a first charging bias, −670 V to the charger 168 so as to charge the photoconductor drum 165 and the transfer bias control means applies, as a first transfer bias, a transfer bias Vₜ₁(0 V<Vₜ₁<50 V) to the primary transfer belt 169. In the present embodiment, the first transfer bias to be applied to the primary transfer belt 169 is set to 10 V.

Then, the image writing means 167 preliminarily exposes the photoconductor drum 165 before the turn-on of the development bias. After that, the charging bias control means applies, as a second charging bias, a regular bias to the charger 168 about 200 msec before the turn-on of the development bias, that is, immediately before the position on the photoconductor drum 165 at which an image is to be formed is passed through the charger 168 to thereby charge the photoconductor drum 165 to −1150 V.

Then, the development bias is turned on to expose a regular image pattern. After that, the transfer bias control means applies, as a second transfer bias, a 215 V regular transfer bias to the primary transfer belt 169 about 150 msec before the turn-on of the development bias, that is, immediately before the position on the photoconductor drum 165 at which the image has been formed reaches the nip portion between itself and primary transfer belt 169.

Although the development unit and image forming apparatus according to the present invention have been described, the present invention is not limited to the above embodiments and a variety of modifications may be made without departing from the scope of the present invention.

What is claimed is:

1. A development unit comprising:
an image carrier;
a charger that charges the image carrier;
image writing means for forming a latent image on the image carrier;
a developer carrier that develops the latent image on the image carrier; and
image write control means for allowing the image writing means to preliminarily expose the image carrier before the position on the image carrier at which an image is to be formed at the time of printing operation is passed through the image writing means.

2. The development unit according to claim 1, wherein
the image writing means preliminarily exposes 5% or more of the image forming area on the image carrier.

3. The development unit according to claim 1, wherein
a pattern of the preliminary exposure is a uniform pattern.

4. An image forming apparatus comprising:
an image carrier;
a charger that charges the image carrier;
image writing means for forming a latent image on the image carrier;
a developer carrier that develops the latent image on the image carrier;
a transfer member onto which the developed image is transferred;
a secondary transfer portion at which the image on the transfer member is transferred onto a transfer medium;
a fixing unit that fixes the image on the transfer medium;
image write control means for allowing the image writing to preliminarily expose the image carrier before the position on the image carrier at which an image is to be formed at the time of printing operation is passed through the image writing means; and
transfer bias control means for applying a transfer bias before the position on the image carrier at which an image has been formed at the time of printing operation reaches the nip portion between the image carrier and transfer member.

5. The image forming apparatus according to claim 4, wherein
the transfer bias control means first applies a first transfer bias and, after that, applies a second transfer bias larger than the first transfer bias immediately before the position on the image carrier at which an image has been formed reaches the nip portion between the image carrier and transfer member.

6. The image forming apparatus according to claim 4, wherein
the transfer member is a transfer belt composed of two or more layers.

7. The image forming apparatus according to claim 4, wherein
the transfer member is composed of a back surface layer positioned on the inner circumferential side, an outermost surface layer positioned on the outer circumferential side, and an intermediate layer sandwiched between the back surface layer and outermost surface layer, and
the following condition is satisfied with respect to the resistance values of the three layers:
back surface layer resistance value>outermost surface layer resistance value>intermediate layer resistance value.

8. An image forming apparatus comprising:
an image carrier;
a charger that charges the image carrier;
image writing means for forming a latent image on the image carrier;
a developer carrier that develops the latent image on the image carrier;
a transfer member onto which the developed image is transferred;
a secondary transfer portion at which the image on the transfer member is transferred onto a transfer medium;
a fixing unit that fixes the image on the transfer medium;
image write control means for allowing the image writing means to preliminarily expose the image carrier before the position on the image carrier at which an image is to be formed at the time of printing operation is passed through the image writing means; and
charging bias control means for applying a charging bias immediately before the position on the image carrier at which an image is to be formed at the time of printing operation is passed through the charger.

9. The image forming apparatus according to claim 8, wherein
the charging bias control means first applies a first charging bias and, after that, applies a second charging bias larger than the first charging bias immediately before the position on the image carrier at which an image is to be formed is passed through the charger.

10. The image forming apparatus according to claim 8, wherein
the transfer member is a transfer belt composed of two or more layers.

11. The image forming apparatus according to claim 8, wherein
the transfer member is composed of a back surface layer positioned on the inner circumferential side, an outermost surface layer positioned on the outer circumferential side, and an intermediate layer sandwiched between the back surface layer and outermost surface layer, and
the following condition is satisfied with respect to the resistance values of the three layers:
back surface layer resistance value>outermost surface layer resistance value>intermediate layer resistance value.
